(19) United States
(12) Patent Application Publication
(10) Pub. No.: US 2025/0274168 A1
(43) Pub. Date: Aug. 28, 2025

(54) MACHINE LEARNING ASSISTED BEAMFORMING HEATMAP DETERMINATION OF A WIRELESS COMMUNICATIONS SYSTEM (WCS)

(71) Applicant: IBWAVE SOLUTIONS INC., Saint-Laurent (CA)

(72) Inventors: Ali Jemmali, Saint-Laurent (CA); Vladan Jevremovic, Houston, TX (US)

(21) Appl. No.: 19/207,899

(22) Filed: May 14, 2025

Related U.S. Application Data
(63) Continuation of application No. PCT/CA2023/051595, filed on Nov. 29, 2023.
(60) Provisional application No. 63/428,791, filed on Nov. 30, 2022.

(51) Int. Cl. H04B 7/0426; H04B 17/391

(52) U.S. Cl. CPC H04B 7/0426; H04B 17/3912; H04B 17/3913

(57) ABSTRACT

Machine learning assisted beamforming heatmap determination of a wireless communications system (WCS) is provided. The WCS includes multiple wireless nodes each configured to form one or more radio frequency (RF) beams to provide RF coverage in a large service venue. To ensure that the wireless nodes can collectively provide a desirable coverage, it is often necessary to compute a beamforming heatmap for each RF channel in each of the wireless nodes. Herein, a computing device is configured to train a machine learning network based on a selected subset of the wireless nodes and then use the trained machine learning network to generate the beamforming heatmaps for all the wireless nodes in the WCS. With assistance from the machine learning network, it is possible to generate and/or regenerate the beamforming heatmap of the WCS with less processing time and/or computational resources to therefore enable fast deployment of the WCS.

### CROSS-REFERENCE TO RELATED APPLICATIONS

This application is a continuation of International Application No. PCT/CA2023/051595, filed Nov. 29, 2023, which claims the benefit of priority of U.S. Provisional Application No. 63/428,791 filed on Nov. 30, 2022, the content of which is relied upon and incorporated herein by reference in its entirety.

### BACKGROUND

The disclosure relates generally to determining a radio frequency (RF) beamforming heat map of a wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute communications signal streams 108(1)-108(S) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective evolved packet core (EPC) network CN1-CNN of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communications signal streams 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

The WCS 100 may be configured to operate as a 5G and/or a 5G-NR communications system. In this regard, the radio node 102 can function as a 5G or 5G-NR base station (a.k.a. eNodeB) to service the wireless client devices 106(1)-106(W). Notably, the 5G or 5G-NR wireless communications system may be implemented based on a millimeter-wave (mmWave) spectrum that can make the communications signals 110(1)-110(N) more susceptible to propagation loss and/or interference. As such, it is desirable to radiate the RF beams 120(1)-120(N) based on a desirable number of RF beams to help mitigate signal propagation loss and/or interference.

### SUMMARY

Embodiments disclosed herein include machine learning assisted beamforming heatmap determination of a wireless communications system (WCS). In examples discussed herein, the WCS includes multiple wireless nodes each configured to form one or more radio frequency (RF) beams to provide RF coverage in a large service venue (e.g., indoor/outdoor stadium, auditorium, etc.). To ensure that the wireless nodes can collectively provide a desirable coverage, it is often necessary to compute a beamforming heatmap for each RF channel in each of the wireless nodes. Conventional methods for computing beamforming heatmaps, such as Ray Tracing or Ray Launching, can take a longer processing time and/or demand a higher computational resource to generate such beamforming heatmaps, which often need to be regenerated when a wireless node(s) is added or removed from the WCS. In embodiments disclosed herein, a computing device is configured to train a machine learning network based on a selected subset of the wireless nodes and then use the trained machine learning network to generate the beamforming heatmaps for all the wireless nodes in the WCS. With assistance from the machine learning network, it is possible to generate and/or regenerate the beamforming heatmap of the WCS with less processing time and/or computational resources to therefore enable fast deployment of the WCS.

One exemplary embodiment of the disclosure relates to a computing device. The computing device includes an input/output (I/O) circuit. The I/O circuit is configured to receive a set of input data related to a plurality of wireless nodes in a WCS. The computing device also includes a processing circuit. The processing circuit is configured to generate a set of formatted data related to the plurality of wireless nodes based on the set of input data. The processing circuit is also configured to generate a training heatmap based on a portion of the set of formatted data related to a selected subset of the plurality of wireless nodes. The processing circuit is also configured to train a machine learning network based on the training heatmap and the portion of the set of formatted data. The processing circuit is also configured to execute the trained machine learning network based on all of the set of formatted data to generate a complete heatmap involving all of the plurality of wireless nodes in the WCS.

An additional exemplary embodiment of the disclosure relates to a method for using machine learning to determine a beamforming heatmap of a WCS. The method includes receiving a set of input data related to a pluSrality of wireless nodes in the WCS. The method also includes generating a set of formatted data related to the plurality of wireless nodes based on the set of input data. The method also includes generating a training heatmap based on a portion of the set of formatted data related to a selected subset of the plurality of wireless nodes. The method also includes training a machine learning network based on the training heatmap and the portion of the set of formatted data. The method also includes executing the trained machine learning network based on all of the set of formatted data to generate a complete heatmap involving all of the plurality of wireless nodes in the WCS.

An additional exemplary embodiment of the disclosure relates to a WCS. The WCS includes a centralized services node coupled to a service node. The WCS also includes a plurality of wireless nodes coupled to the centralized services node. The WCS also includes a computing device. The computing device includes an I/O circuit. The I/O circuit is configured to receive a set of input data related to the plurality of wireless nodes in the WCS. The computing device also includes a processing circuit. The processing circuit is configured to generate a set of formatted data related to the plurality of wireless nodes based on the set of input data. The processing circuit is also configured to generate a training heatmap based on a portion of the set of formatted data related to a selected subset of the plurality of wireless nodes. The processing circuit is also configured to train a machine learning network based on the training heatmap and the portion of the set of formatted data. The processing circuit is also configured to execute the trained machine learning network based on all of the set of formatted data to generate a complete heatmap involving all of the plurality of wireless nodes in the WCS.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIGS. 2A-2B are graphic diagrams providing exemplary illustrations of a number of fundamental aspects related to radio frequency (RF) beamforming;

FIG. 3 is a schematic diagram of an exemplary WCS wherein a computing device can be employed to perform machine learning assisted beamforming heatmap determination according to embodiments of the present disclosure;

FIGS. 4A-4B illustrate an exemplary stadium wherein the WCS of FIG. 3 can be deployed and the computing device can be configured to perform machine learning assisted beamforming heatmap determination;

FIG. 5 is a schematic diagram providing an exemplary illustration of the computing device in the WCS of FIG. 3;

FIG. 6 is a flowchart of an exemplary process that can be employed by the computing device of FIG. 5 for performing machine learning assisted beamforming heatmap determination;

FIG. 7 is a flowchart providing a detailed illustration of the process in FIG. 6;

FIG. 8 is a partial schematic cut-away diagram of an exemplary building infrastructure in a WCS, such as the WCS of FIG. 3 that includes the computing device of FIG. 5 to perform machine learning assisted beamforming heatmap determination;

FIG. 9 is a schematic diagram of an exemplary mobile telecommunications environment that can includes the WCS of FIG. 3 that includes the computing device of FIG. 5 to perform machine learning assisted beamforming heatmap determination; and

FIG. 10 is a schematic diagram of a representation of an exemplary computer system that can be included in or interfaced with any of the components in the WCS of FIG. 3 and the computing device in FIG. 5 to perform machine learning assisted beamforming heatmap determination, wherein the exemplary computer system is configured to execute instructions from an exemplary computer-readable medium.

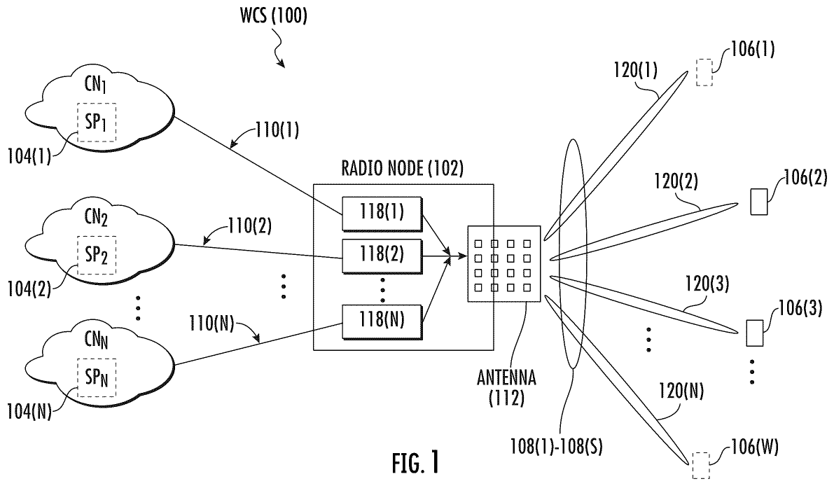

### DETAILED DESCRIPTION

Embodiments disclosed herein include machine learning assisted beamforming heatmap determination of a wireless communications system (WCS). In examples discussed herein, the WCS includes multiple wireless nodes each configured to form one or more radio frequency (RF) beams to provide RF coverage in a large service venue (e.g., indoor/outdoor stadium, auditorium, etc.). To ensure that the wireless nodes can collectively provide a desirable coverage, it is often necessary to compute a beamforming heatmap for each RF channel in each of the wireless nodes. Conventional methods for computing beamforming heatmaps, such as Ray Tracing or Ray Launching, can take a longer processing time and/or demand a higher computational resource to generate such beamforming heatmaps, which often need to be regenerated when a wireless node(s) is added or removed from the WCS. In embodiments disclosed herein, a computing device is configured to train a machine learning network based on a selected subset of the wireless nodes and then use the trained machine learning network to generate the beamforming heatmaps for all the wireless nodes in the WCS. With assistance from the machine learning network, it is possible to generate and/or regenerate the beamforming heatmap of the WCS with less processing time and/or computational resources to therefore enable fast deployment of the WCS.

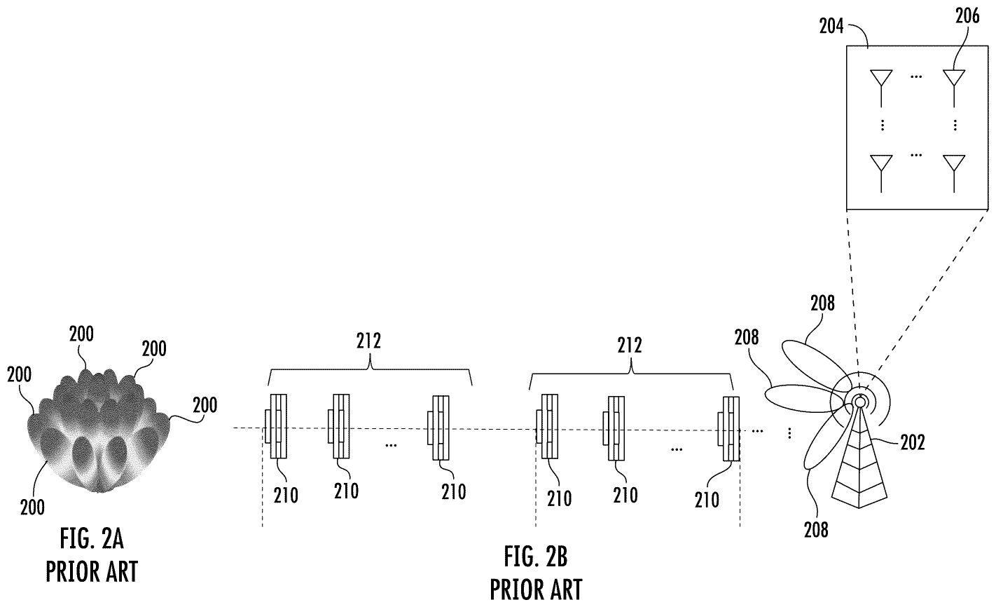

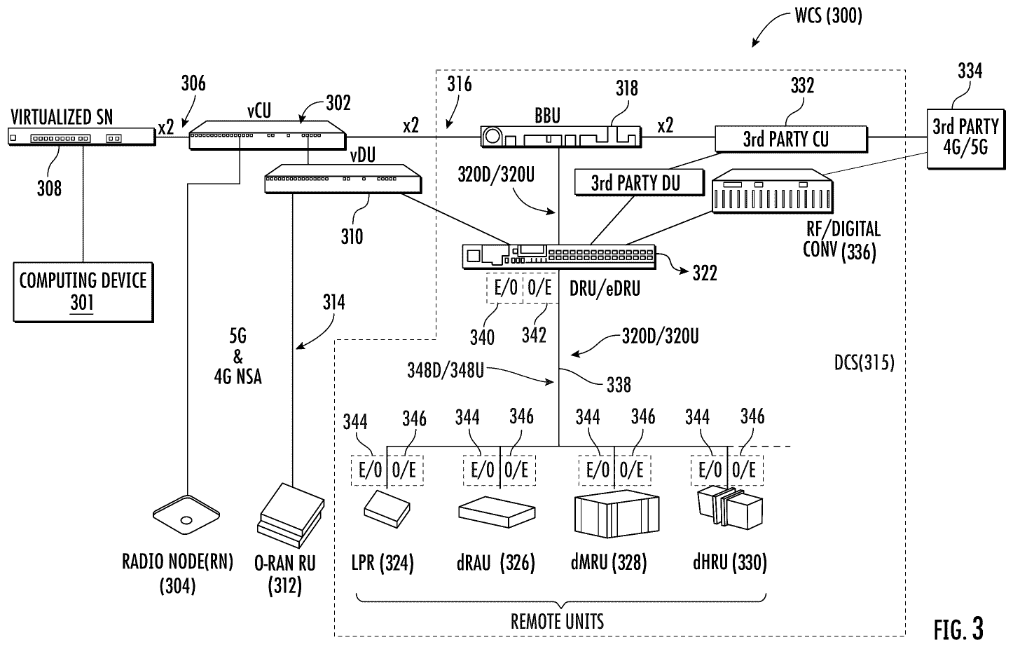

Before discussing a wireless node of the present disclosure configured to synthesize a beamforming codebook(s), starting at FIG. 3, a brief overview of a conventional beamforming system is first provided with reference to FIGS. 2A-2B to help explain some fundamental aspects related to radio frequency (RF) beamforming.

In this regard, FIGS. 2A-2B are graphic diagrams providing exemplary illustrations of fundamental aspects related to RF beamforming. In general, beamforming refers to a technique that uses multiple antenna elements to simultaneously emit an RF signal. The antenna elements are typically organized into an antenna array (e.g., 4×4, 8×8, 16×16, etc.) and separated from each other by a distance (e.g., ½ wavelength). The RF signal emitted from the antenna elements is preprocessed based on a set of complex-valued coefficients, which is commonly known as a codeword. Specifically, the codeword is physically realized through phase and/or amplitude control applied at input of the antenna elements to thereby maximize array gain in a specific direction. By applying the set of complex-valued coefficients to the RF signal, the multiple simultaneously emitted RF signals can form a radiation pattern (a.k.a. RF beam) described by gain, intensity, power, and/or electric/magnetic field values versus elevation and azimuth directions. In this regard, it can be said that each RF beam is associated with, or defined by, a respective codeword. In other words, there is a one-to-one relationship between an RF beam and a codeword. Accordingly, a list of different codewords, often referred to as a codebook, can define multiple different RF beams. As illustrated in FIG. 2A, by pre-processing the RF signal based on different codewords, it may be possible to form multiple RF beams 200 pointing to multiple directions.

Notably, the radiation pattern often includes a main lobe, where the radiation power is concentrated and close to a maximum radiated power, and one or more side lobes with lesser amounts of radiated power. Typically, a radiation direction of the main lobe determines a radiation direction of the RF beam, and a beamwidth of the RF beam is defined by a set of radiation directions of the radiation pattern wherein a radiated power is not lower than 3 dB from the maximum radiated power.

In the context of the present disclosure, the RF beams 200 are known as control beams or reference beams that enable a user device to discover a transmitting base station. Although, in theory, it is possible to increase the number of the RF beams 200 by defining more codewords, an actual number of the RF beams 200 is typically limited by a standard-defined parameter known as the synchronization signal block (SSB). FIG. 2B is a graphic diagram providing an exemplary illustration of how the SSB limits the actual number of the RF beams 200 that may be formed by a wireless node 202 (e.g., gNB) configured to operate according to the third-generation partnership project (3GPP) standard.

As shown in FIG. 2B, the wireless node 202 includes an antenna array 204 having multiple antenna elements 206. To allow any user equipment (UE) in an intended coverage area to detect the wireless node 202, the wireless node 202 is configured to periodically radiate multiple reference beams 208 (a.k.a. control beams) in different directions of the intended coverage cell. Like the RF beam 200, each of the reference beams 208 is formed based on a respective codeword as described above. The reference beams 208 are each associated with a respective one of multiple SSBs 210. Each of the SSBs 210 may include such information as a primary synchronization signal (PSS), a secondary synchronization signal (SSS), and a 5G-NR physical broadcast channel (PBCH) to enable the UE to discover the wireless node 202.

According to a conventional beamforming approach, the wireless node 202 is configured to sequentially steer the reference beams 208 toward different directions, which is often predetermined in the codewords, in the coverage area. Accordingly, a UE can sweep through the reference beams 208 to identify a candidate reference beam(s) associated with a strongest reference signal received power (RSRP). Further, the UE may decode a candidate SSB(s) associated with the identified candidate reference beam(s) to acquire such information as physical cell identification (PCI) and a PBCH demodulation reference signal (DMRS). Based on the candidate reference beam(s) reported by the UE, the wireless node 202 may pinpoint a location of the UE and subsequently steer a data-bearing RF beam toward the UE to enable data communication with the UE. The SSBs 210 may be organized into an SSB burst set 212 to be repeated periodically based on a predefined SSB burst interval. The current 3GPP standard allows a maximum of 64 SSBs to be scheduled in the SSB burst set 212. Accordingly, the wireless node 202 can radiate up to 64 reference beams 208 during each SSB burst interval.

To ensure that the reference beams 208 can provide a desired coverage in the intended coverage area, a beamforming heatmap(s) is often computed for each of the reference beams 208 to help determine energy concentration or spread of each of the reference beams 208. Conventional methods for determining such beamforming heatmaps include Ray Tracing and Ray Launching. Given that a complete WCS can include a large number (e.g., >100) of the wireless node 202 and each wireless node 202 can serve multiple RF channels, the conventional methods for determine the beamforming heatmaps across the WCS can take a longer processing time and/or demand a significant amount of computational resource. Moreover, such beamforming heatmap computation must be repeated whenever a new wireless node 202 is added or an existing wireless node 202 is removed. As such, it is desirable to reduce the processing time and the demand for computational resource associated computing the beamforming heatmaps.

In this regard, FIG. 3 is a schematic diagram of an exemplary WCS 300 wherein a computing device 301 can be employed to perform machine learning assisted beamforming heatmap determination according to embodiments of the present disclosure. In a non-limiting example, the computing device 301 can be a personal computer (e.g., laptop or desktop), a cloud-based computer server, and so on.

The WCS 300 supports both legacy 4G LTE, 4G/5G non-standalone (NSA), and 5G standalone communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to a radio node 304 (e.g., 5G or 5G-NR gNB). Despite that only one radio node 304 is shown in FIG. 3, it should be appreciated that the WCS 300 can be configured to include additional numbers of the radio node 304, as needed. In one embodiment, the computing device 301 may be provided as part of the centralized services node 302.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a wireless node refers generally to a wireless communication circuit including at least a processing circuit, a memory circuit, and an antenna circuit, and can be configured to process, transmit, and receive a wireless communications signal. In this regard, the radio node 304, the O-RAN RN 312, the LPR 324, the dRAU 326, the dMRU 328, and the dHRU 330 can each function as a wireless node to provide RF coverage at an intended service venue. Notably, the WCS 300 can be deploy in a variety of venues, including but not limited to indoor/outdoor stadium, indoor/outdoor auditorium, and so on.

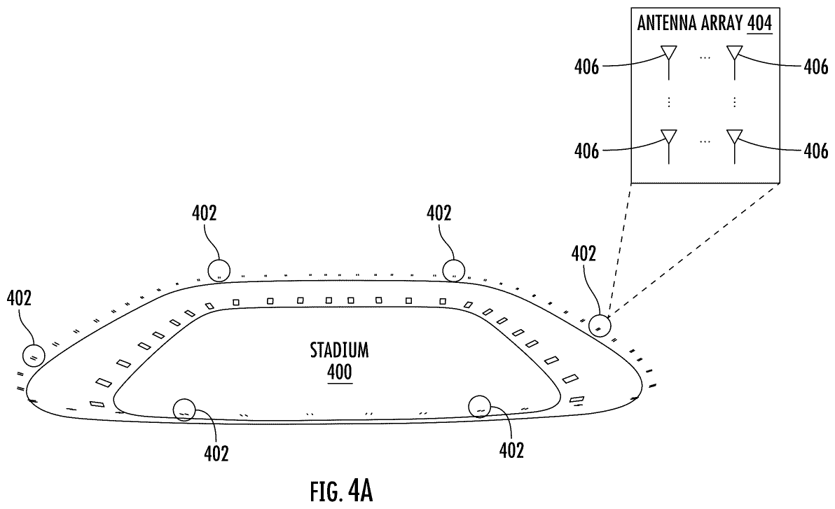

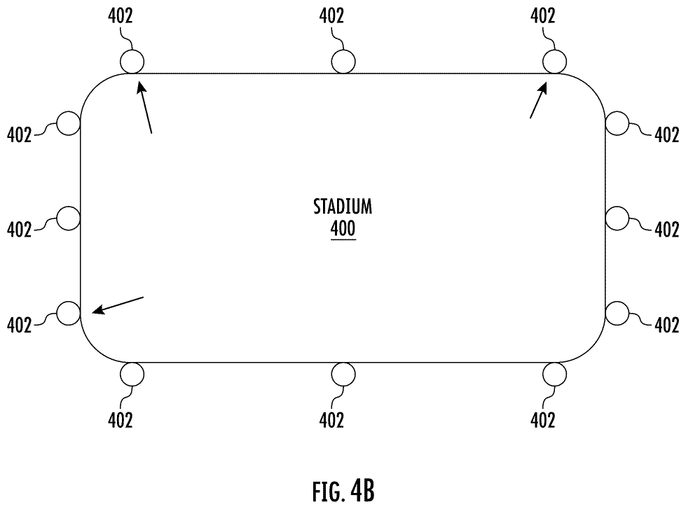

FIGS. 4A-4B illustrate an exemplary stadium 400 wherein the WCS 300 of FIG. 3 can be deployed and the computing device 301 can be configured to perform machine learning assisted beamforming heatmap determination. FIG. 4A is a schematic diagram illustrating a plurality of wireless nodes 402 each including a respective one of a plurality of antenna arrays 404 having multiple antenna elements 406. In a non-limiting example, the stadium 400 has a symmetrical geometrical shape (e.g., rectangular shaped, octagonal shaped, etc.) and the antenna arrays 404 are mounted on top of the stadium 400 to provide line-of-sight beamforming coverage.

FIG. 4B is an exemplary top view of the stadium 400 of FIG. 4A. Common elements between FIGS. 4A and 4B are shown therein with common element numbers and will not be re-described herein. As described in detail below, a set of input data related to all the wireless nodes 400 is first collected and provided to the computing device 301 in FIG. 3. In a non-limiting example, the set of input data can include a venue geometry of the stadium 400, an antenna pattern of each of the antenna arrays 404, a property of materials in the stadium 400 that can cause signal attenuation and/or reflection, and a transmit power and/or a transmit frequency of each of the wireless nodes 402. The computing device 301 can process the input data to generate a set of formatted data related to all the wireless nodes 402 deployed in the stadium 400. The computing device 301 then computes a training heatmap for a subset of the wireless nodes 402 (e.g., the wireless nodes 402 pointed by arrows) using such conventional heatmap generation methods as Ray Tracing and/or Ray Launching. The computing device 301 then trains a machine learning network based on the training heatmap and subsequently uses the trained machine learning network to determine a complete heatmap for all the wireless nodes 402 deployed at the stadium 400. In context of the present disclosure, the machine learning network can be an artificial neural network (ANN) based machine learning module or a non-ANN based machine learning module. With assistance from the machine learning network, it is possible to generate and/or regenerate the beamforming heatmap of the WCS 300 deployed at the stadium 400 with less processing time and/or computational resources than relying solely on the conventional methods. As such, it is not only possible to perform an initial coverage assessment of the stadium 400 quicker, but also possible to reperform the coverage assessment without having to retrain the machine learning network when adding and/or removing any of the wireless nodes 402.

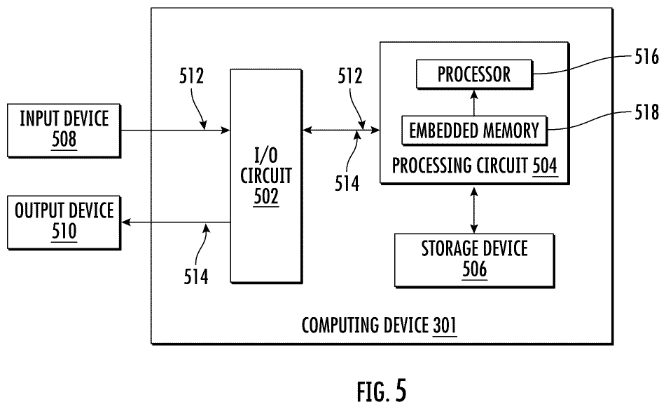

FIG. 5 is a schematic diagram providing an exemplary illustration of the computing device 301 in the WCS 300 of FIG. 3. Common elements between FIGS. 3 and 5 are shown therein with common element numbers and will not be re-described herein.

In an embodiment, the computing device 301 includes an input/output (I/O) circuit 502, a processing circuit 504, and a storage device 506. The I/O circuit 502 may include or be communicatively coupled to an input device 508 and an output device 510. The input device 508 may be a computer keyboard, a scanner, a media reader, and so on. The output device 510 may be a computer monitor, a printer, a portable or cloud-based storage device, and so on. According to an embodiment of the present disclosure, the input device 508 is configured to provide a set of input data 512 related to the wireless nodes 402 in the stadium 400 to the I/O circuit 502, while the output device 510 is configured to output a complete heatmap 514 generated by the processing circuit 504.

The processing circuit 504, which can be a field-programmable gate array (FPGA) or an application-specific integrated circuit (ASIC), as an example, includes at least one processor 516 (e.g., a microprocessor) and an embedded memory 518 (e.g., a flash memory). In a non-limiting example, the embedded memory 518 can store computer instructions to program the processor 516 to carry out machine learning assisted beamforming heatmap determination as well as intermediate and/or final data generated by the processor 516.

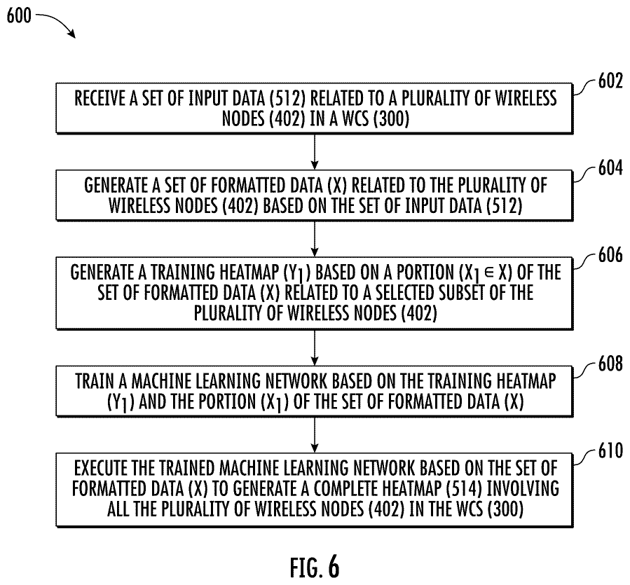

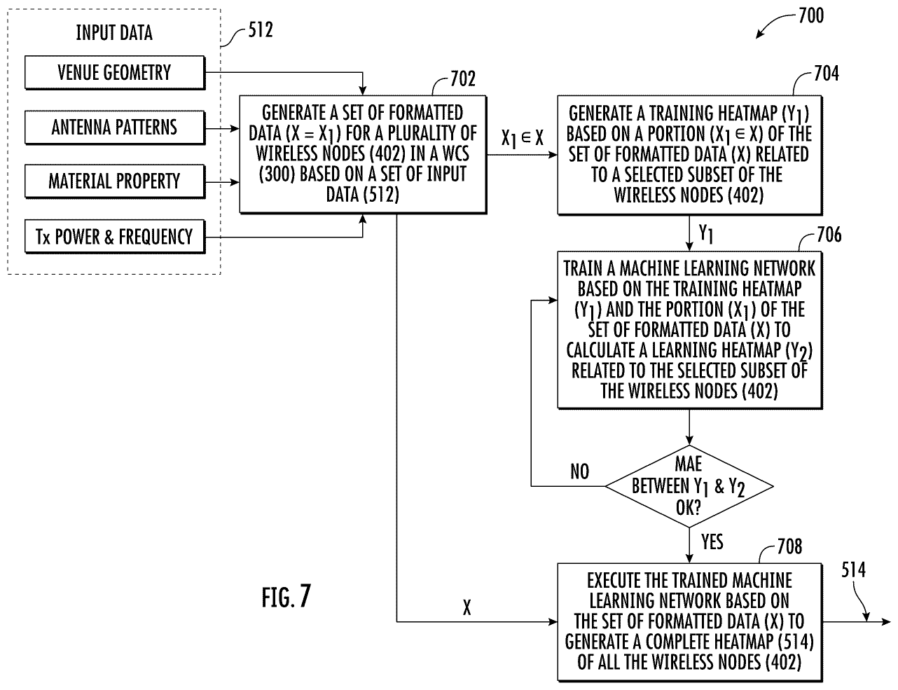

The processor 516 can be configured to perform machine learning assisted beamforming heatmap determination according to a process. In this regard, FIG. 6 is a flowchart of an exemplary process 600 that can be employed by the processing circuit 504 in the computing device 301 of FIG. 5 for performing machine learning assisted beamforming heatmap determination.

According to the process 600, the processor 516 first receives the set of input data 512 that is related to all the wireless nodes 402 in the WCS 300 (block 602). As mentioned earlier, the set of input data may include such information as venue geometry, antenna pattern, property of materials, and transmit power and/or frequency. It should be appreciated that the set of input data 512 may include additional configuration data that can help calculate a beamforming heatmap of the WCS 300.

Next, the processor 516 generates a set of formatted data (hereinafter referred to as “X”) that is related to all the wireless nodes 400 based on the set of input data 512 (block 604). Herein, the set of formatted data X is a set of configuration information extrapolated from the set of input data 512 and formatted to be processed by the conventional Ray Tracing and/or Ray Launching methods.

The processor 516 then uses the conventional Ray Tracing or Ray Launching method to generate a training heatmap (referred to as “Y₁” hereinafter) based on a portion (hereinafter referred to as “X₁,” X₁∈X) of the formatted data X that is related to a selected subset of the wireless nodes 402 (block 606), such as the three wireless nodes 402 in FIG. 4B pointed by the arrows. Studies have shown that, regardless of how many of the wireless nodes 402 are included in the WCS 300, it is sufficient to generate the training heatmap with no more than three (3) of the wireless nodes 402. Understandably, by generating the training heatmap Y₁ based on a small number of the wireless nodes 402, it is possible to reduce processing time in generating the training heatmap Y₁ using the conventional Ray Tracing or Ray Launching method.

The processor 516 will then train a machine learning network based on the training heatmap Y₁ and the portion X₁ of the set of formatted data X (block 608). In an embodiment, during the training, the machine learning network will generate a learning heatmap (hereinafter referred to as “Y₂”) based on the portion X₁ of the formatted data X that is related to the subset of the wireless nodes 402. The machine learning network may be fine-tuned in one or more iterations until a mean average error (MAE) between the training heatmap Y₁ and the learning heatmap Y₂ is reduced to a defined threshold. At this point, the training for the machine learning network is deemed complete. In addition, the machine learning network does not need to be retrained when a new wireless node is added to the wireless nodes 402 or an existing wireless node is removed from the wireless nodes 402.

The processor 516 can then execute the trained machine learning network based on a whole set of the formatted data X to generate the complete heatmap 514 involving all the wireless nodes 402 in the WCS 300 (block 610). When a new wireless node is added to the wireless nodes 402 or an existing wireless node is removed from the wireless nodes 402, the processor 516 can simply execute the machine learning network again to regenerate the complete heatmap 514.

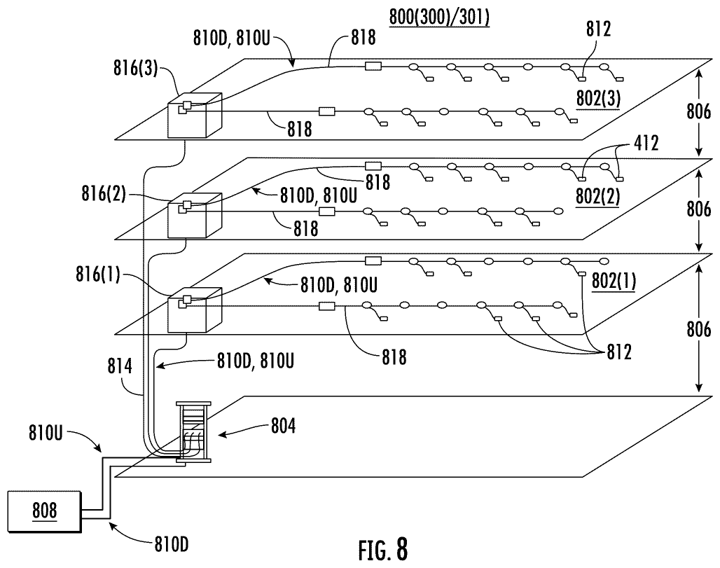

FIG. 7 is a flowchart of a process 700 providing a detailed illustration of the process 600 in FIG. 6. According to the process 700, the processor 516 generates the set of formatted data X that is related to all the wireless nodes 402 based on the set of input data 512 (block 702). The processor 516 then generates the training heatmap Y₁ based on the portion X₁, of the formatted data X that is related to the subset of the wireless nodes 402 (block 704). The processor 516 will then train the machine learning network based on the training heatmap Y₁ and the portion X₁ of the set of formatted data X to calculate the learning heatmap Y₂ related to the selected subset of the wireless nodes 402 (block 706). The processor 516 may fine-tune the machine learning network until the MAE between the training heatmap Y₁ and the learning heatmap Y₂ is reduced to the predefined threshold. The processor 516 can then execute the trained machine learning network based on the set of the formatted data X to generate the complete heatmap 514 involving all the wireless nodes 402 in the WCS 300 (block 708).

In an alternative embodiment, the processor 516 may also generate the training heatmap Y₁ based on a field survey module that includes field data taken at a venue (e.g., the stadium 400 in FIG. 4A). In another embodiment, the processor 516 may also generate the training heatmap Y₁ based the field survey module in combination with a Ray Tracing or Ray Launching module.

The WCS 300 of FIG. 3, which can include the computing device 301 in FIG. 5, can be provided in an indoor environment as illustrated in FIG. 8. FIG. 8 is a partial schematic cut-away diagram of an exemplary building infrastructure 800 in a WCS, such as the WCS 300 of FIG. 3 that includes the computing device 301 of FIG. 5 to perform machine learning assisted beamforming heatmap determination. The building infrastructure 800 in this embodiment includes a first (ground) floor 802(1), a second floor 802(2), and a third floor 802(3). The floors 802(1)-802(3) are serviced by a central unit 804 to provide antenna coverage areas 806 in the building infrastructure 800. The central unit 804 is communicatively coupled to a base station 808 to receive downlink communications signals 810D from the base station 808. The central unit 804 is communicatively coupled to a plurality of remote units 812 to distribute the downlink communications signals 810D to the remote units 812 and to receive uplink communications signals 810U from the remote units 812, as previously discussed above. The downlink communications signals 810D and the uplink communications signals 810U communicated between the central unit 804 and the remote units 812 are carried over a riser cable 814. The riser cable 814 may be routed through interconnect units (ICUs) 816(1)-816(3) dedicated to each of the floors 802(1)-802(3) that route the downlink communications signals 810D and the uplink communications signals 810U to the remote units 812 and also provide power to the remote units 812 via array cables 818.

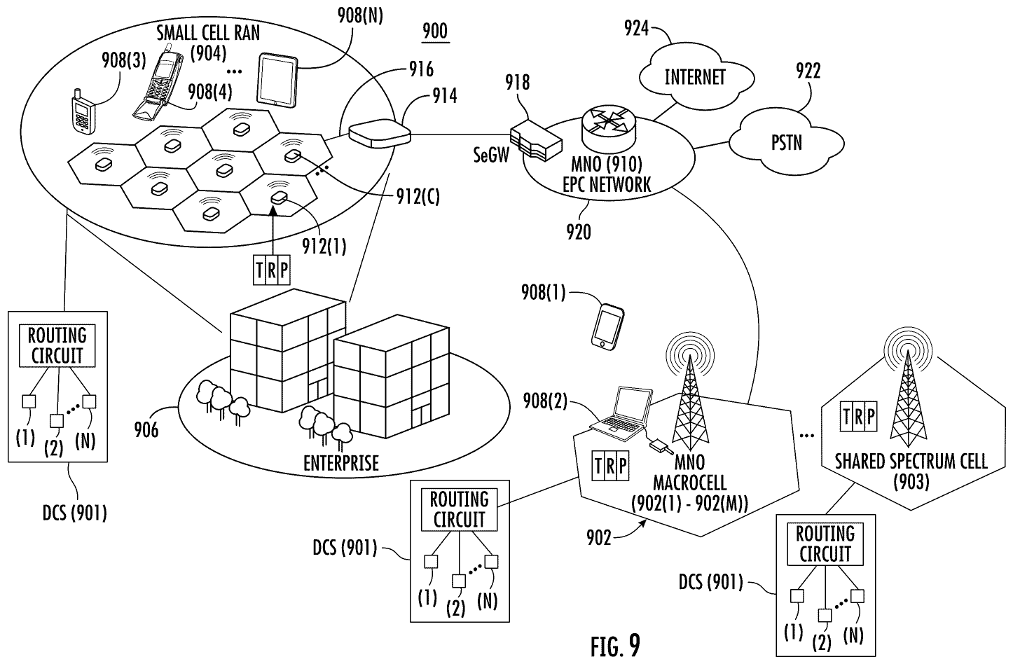

The WCS 300 of FIG. 3 and the computing device 301 of FIG. 5, configured to perform machine learning assisted beamforming heatmap determination, can also be interfaced with different types of radio nodes of service providers and/or supporting service providers, including macrocell systems, small cell systems, and remote radio heads (RRH) systems, as examples. For example, FIG. 9 is a schematic diagram of an exemplary mobile telecommunications environment 900 (also referred to as “environment 900”) that includes radio nodes and cells that may support shared spectrum, such as unlicensed spectrum, and can be interfaced to shared spectrum WCSs 901 supporting coordination of distribution of shared spectrum from multiple service providers to remote units to be distributed to subscriber devices. The shared spectrum WCSs 901 can include the WCS 300 of FIG. 3 that includes the computing device 301 of FIG. 5, as an example.

The environment 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to a mobile network operator (MNO) 910. A serving RAN for the user mobile communications devices 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas the user mobile communications devices 908(1) and 908(2) are being serviced by the macrocell 902. The macrocell 902 is an MNO macrocell in this example. However, a shared spectrum RAN 903 (also referred to as “shared spectrum cell 903”) includes a macrocell in this example and supports communications on frequencies that are not solely licensed to a particular MNO, such as CBRS for example, and thus may service user mobile communications devices 908(1)-908(N) independent of a particular MNO. For example, the shared spectrum cell 903 may be operated by a third party that is not an MNO and wherein the shared spectrum cell 903 supports CBRS. Also, as shown in FIG. 9, the MNO macrocell 902, the shared spectrum cell 903, and/or the small cell RAN 904 can interface with a shared spectrum WCS 901 supporting coordination of distribution of shared spectrum from multiple service providers to remote units to be distributed to subscriber devices. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO macrocell 902, the shared spectrum cell 903, and the small cell RAN 904 depending on the location of the user mobile communications devices 908(3)-908(N).

In FIG. 9, the mobile telecommunications environment 900 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 900 includes the enterprise environment 906 in which the small cell RAN 904 is implemented. The small cell RAN 904 includes a plurality of small cell radio nodes 912(1)-912(C). Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g., evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The environment 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the environment 900.

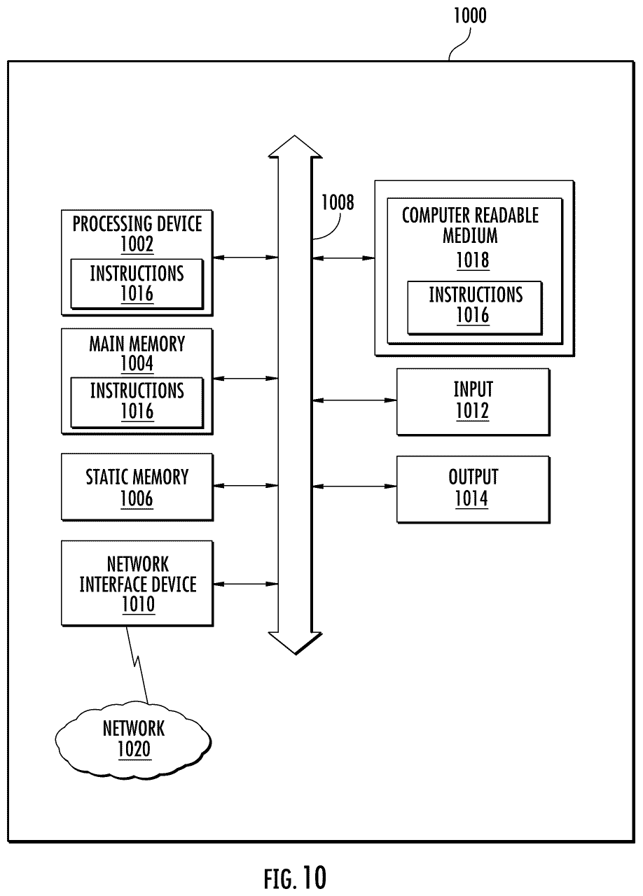

Any of the circuits in the WCS 300 of FIG. 3 and the computing device 301 of FIG. 5, such as the processing circuit 504, can include a computer system 1000, such as that shown in FIG. 10, to carry out their functions and operations. With reference to FIG. 10, the computer system 1000 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1000 in this embodiment includes a processing circuit or processor 1002, a main memory 1004 (e.g., read-only memory (ROM), flash memory, dynamic random access memory (DRAM) such as synchronous DRAM (SDRAM), etc.), and a static memory 1006 (e.g., flash memory, static random access memory (SRAM), etc.), which may communicate with each other via a data bus 1008. Alternatively, the processing circuit 1002 may be connected to the main memory 1004 and/or static memory 1006 directly or via some other connectivity means. The processing circuit 1002 may be a controller, and the main memory 1004 or static memory 1006 may be any type of memory.

The processing circuit 1002 represents one or more general-purpose processing circuits such as a microprocessor, central processing unit, or the like. More particularly, the processing circuit 1002 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1002 is configured to execute processing logic in instructions 1016 for performing the operations and steps discussed herein.

The computer system 1000 may further include a network interface device 1010. The computer system 1000 also may or may not include an input 1012 to receive input and selections to be communicated to the computer system 1000 when executing instructions. The computer system 1000 also may or may not include an output 1014, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1000 may or may not include a data storage device that includes instructions 1016 stored in a computer-readable medium 1018. The instructions 1016 may also reside, completely or at least partially, within the main memory 1004 and/or within the processing circuit 1002 during execution thereof by the computer system 1000, the main memory 1004 and the processing circuit 1002 also constituting the computer-readable medium 1018. The instructions 1016 may further be transmitted or received over a network 1020 via the network interface device 1010.

While the computer-readable medium 1018 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A computing device, comprising:
an input/output (I/O) circuit configured to receive a set of input data related to a plurality of wireless nodes in a wireless communications system (WCS); and
a processing circuit configured to:
generate a set of formatted data related to the plurality of wireless nodes based on the set of input data;
generate a training heatmap based on a portion of the set of formatted data related to a selected subset of the plurality of wireless nodes;
train a machine learning network based on the training heatmap and the portion of the set of formatted data; and
execute the trained machine learning network based on all of the set of formatted data to generate a complete heatmap involving all of the plurality of wireless nodes in the WCS.

2. The computing device of claim 1, wherein the processing circuit is further configured to execute one or more of a Ray Tracing module and a Ray Launching module to generate the training heatmap based on the portion of the set of formatted data.

3. The computing device of claim 1, wherein the processing circuit is further configured to execute a field survey module to generate the training heatmap based on the portion of the set of formatted data.

4. The computing device of claim 1, wherein the processing circuit is further configured to execute one or more of a Ray Tracing module, a Ray Launching module, and a field survey module to generate the training heatmap based on the portion of the set of formatted data.

5. The computing device of claim 1, wherein the selected subset of the plurality of wireless nodes comprises no more than three of the plurality of wireless nodes.

6. The computing device of claim 1, wherein the processing circuit is further configured to:
execute the machine learning network based on the training heatmap to thereby generate a learning heatmap; and
train the machine learning network in one or more iterations to reduce a mean average error (MAE) between the learning heatmap and the training heatmap to a defined threshold.

7. The computing device of claim 1, wherein the processing circuit is further configured not to retrain the machine learning network when a wireless node is removed from and/or added into the WCS.

8. A method for using machine learning to determine a beamforming heatmap of a wireless communications system (WCS), comprising:
receiving a set of input data related to a plurality of wireless nodes in the WCS;
generating a set of formatted data related to the plurality of wireless nodes based on the set of input data;
generating a training heatmap based on a portion of the set of formatted data related to a selected subset of the plurality of wireless nodes;
training a machine learning network based on the training heatmap and the portion of the set of formatted data; and
executing the trained machine learning network based on all of the set of formatted data to generate a complete heatmap involving all of the plurality of wireless nodes in the WCS.

9. The method of claim 8, further comprising executing one or more of a Ray Tracing module and a Ray Launching module to generate the training heatmap based on the portion of the set of formatted data.

10. The method of claim 8, further comprising executing a field survey module to generate the training heatmap based on the portion of the set of formatted data.

11. The method of claim 8, further comprising executing one or more of a Ray Tracing module, a Ray Launching module, and a field survey module to generate the training heatmap based on the portion of the set of formatted data.

12. The method of claim 8, further comprising determining the selected subset of the plurality of wireless nodes to include no more than three of the plurality of wireless nodes.

13. The method of claim 8, further comprising:
executing the machine learning network based on the training heatmap to thereby generate a learning heatmap; and
training the machine learning network in one or more iterations to reduce a mean average error (MAE) between the learning heatmap and the training heatmap to a defined threshold.

14. The method of claim 8, further comprising not retraining the machine learning network when a wireless node is removed from and/or added into the WCS.

15. The method of claim 8, further comprising determining the selected subset of the plurality of wireless nodes to be spatially separated and having a similar radiation orientation.

16. A wireless communications system (WCS), comprising:
a centralized services node coupled to a service node;
a plurality of wireless nodes coupled to the centralized services node; and
a computing device, comprising:
an input/output (I/O) circuit configured to receive a set of input data related to the plurality of wireless nodes in the WCS; and
a processing circuit configured to:
generate a set of formatted data related to the plurality of wireless nodes based on the set of input data;
generate a training heatmap based on a portion of the set of formatted data related to a selected subset of the plurality of wireless nodes;
train a machine learning network based on the training heatmap and the portion of the set of formatted data; and
execute the trained machine learning network based on all of the set of formatted data to generate a complete heatmap involving all of the plurality of wireless nodes in the WCS.

17. The WCS of claim 16, wherein the plurality of wireless nodes comprises one or more of: at least one radio node, at least one radio access network (RAN) node, and a plurality of remote units.

18. The WCS of claim 16, wherein the centralized services node comprises the computing device.

19. The WCS of claim 16, further comprising a routing unit (RU) coupled to a plurality of remote units via a plurality of optical fiber-based communications mediums.

20. The WCS of claim 19, wherein:
the RU comprises:
an electrical-to-optical (E/O) converter configured to convert the plurality of downlink communications signals into a plurality of downlink optical communications signals, respectively; and
an optical-to-electrical (O/E) converter configured to convert a plurality of uplink optical communications signals into the plurality of uplink communications signals, respectively; and
the plurality of remote units each comprises:
a respective O/E converter configured to convert a respective one of the plurality of downlink optical communications signals into a respective one of the plurality of downlink communications signals; and
a respective E/O converter configured to convert a respective one of the plurality of uplink communications signals into a respective one of the plurality of uplink optical communications signals.
